(19) United States
(12) Patent Application Publication
(10) Pub. No.: US 2009/0206093 A1
(43) Pub. Date: Aug. 20, 2009

(54) NON-STICK COOKING DEVICE

(75) Inventor: Juan M. Knight, Waldwick, NJ (US)

Correspondence Address: FOLEY & LARDNER LLP, 777 EAST WISCONSIN AVENUE, MILWAUKEE, WI, 53202-5306, US

(73) Assignee: Maverick Cuisine LLC

(21) Appl. No.: 12/163,666

(22) Filed: Jun. 27, 2008

Related U.S. Application Data
(60) Provisional application No. 61/028,708, filed on Feb. 14, 2008.

(51) Int. Cl. A47J 36/02; B23P 25/00

(52) U.S. Cl. 220/573.2; 99/447; 29/527.2

(57) ABSTRACT

A self-contained high-temperature non-stick cooking device includes a heat-conducting platform having a first side and a second side, and a hardened layer on the first side of the heat-conducting platform and having a polished surface, and a non-stick layer on the polished surface, and a non-reflective coating disposed on the second side of the heat-conducting platform, and a heat source adjacent to the non-reflective black-body coating for heating the heat-conducting platform.

### CROSS REFERENCE TO RELATED APPLICATIONS

The present Application claims the benefit of priority of co-pending U.S. Provisional Patent Application No. 61/028,708 titled “Ceramic Coated Cooking Device” filed on Feb. 14, 2008, the disclosure of which is hereby incorporated by reference in its entirety.

### FIELD

The present invention relates generally to a non-stick cooking device. The present invention relates more particularly to a self-contained non-stick cooking device having a cooking surface formed from a heat conductive material that is surface hardened and polished on one side with a non-stick layer applied thereto and capable of withstanding high temperatures for cooking or finishing food products thereon. The present invention further relates to a self-contained non-stick cooking device having a high emissivity coating on an opposite side for maximizing heat transfer from a heat source. The present invention further relates to a self-contained non-stick cooking device intended for permanent or semi-permanent installation in a facility.

### BACKGROUND

This section is intended to provide a background or context to the invention recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Cooking devices such as griddles, grills, hot plates, planchas and the like for operation at high temperatures are generally known. Such cooking devices usually have a cooking surface heated by a heat source for cooking food products thereon. However, such known cooking devices usually are uncoated, or coated with a material that does not provide a desired degree of non-stick performance and typically require extensive effort and time to clean the cooking surface, and often require harsh or abrasive cleaners that tend to damage or reduce the useful life of the cooking surface. Further, such known cooking devices often do not include a desired combination of material characteristic and coatings intended to maximize heat transfer from a heat source, while providing a durable, wear resistant surface having a coating capable of withstanding the high temperatures (e.g. temperatures of about 500° F. or greater) often required by commercial or institutional cooking applications. Other cooking devices such as utensils (pots, pans, etc.) are also generally known and may include a non-stick surface treatment or coating, however such utensils are typically not suitable for use as a permanent or semi-permanent installation within a facility (e.g. commercial or institutional kitchen, etc.) for processing or finishing large quantities of food products.

Accordingly, it would be desirable to provide a self-contained multi-layer high-temperature non-stick (i.e. stick resistant) cooking device or appliance or the like of a type disclosed in the present Application.

### SUMMARY

One embodiment of the present invention relates to a self-contained non-stick high-temperature cooking device that includes a heat-conducting platform having a first side and a second side, and a hardened layer on the first side of the heat-conducting platform and having a polished surface, and a non-stick layer on the polished surface, and a non-reflective coating disposed on the second side of the heat-conducting platform, and a heat source adjacent to the non-reflective coating for heating the heat-conducting platform.

Another embodiment of the present invention relates to a method of making a self-contained non-stick high-temperature cooking device and includes the steps of providing a heat-conducting platform, hardening a surface of the heat-conducting platform to provide a hardened layer, polishing the hardened layer to provide a polished surface, depositing a layer of non-stick material on the polished surface, the layer of non-stick material configured to receive a food product thereon, and providing a heat source adjacent to the heat-conducting platform and operable to heat the heat-conducting platform and the layer of non-stick material.

A further embodiment of the present invention relates to a self-contained non-stick high-temperature cooking device and includes a plate formed from a heat conductive material, the plate having a perimeter and a first side and a second side, a hardened layer formed on the first side of the plate and having a polished surface, a non-stick layer disposed on the polished surface, the non-stick layer configured to receive articles thereon to be heated by the plate, a non-reflective coating disposed on the second side of the plate, a heating element disposed adjacent to the non-reflective coating and configured to heat the plate; and a frame having a first surface supporting the heating element, and a second surface supporting the plate above the heating element, and a trough at least partially surrounding the perimeter of the plate

### BRIEF DESCRIPTION OF THE DRAWINGS

FIG. 1 is a schematic representation of an exploded perspective view of a self-contained high-temperature non-stick cooking device according to one embodiment.

FIG. 2A is a schematic representation of a sectional view of a heat-conducting platform (shown for example as a plate) of the self-contained high-temperature non-stick cooking device according to the embodiment of FIG. 1.

FIG. 2B is a schematic representation of a sectional view of another embodiment of a heat-conducting platform of the self-contained high-temperature non-stick cooking device.

FIG. 3 is a schematic representation of a perspective view of a self-contained high-temperature non-stick cooking device according to another embodiment.

FIG. 4 is a schematic representation of a sectional view of the self-contained high-temperature non-stick cooking device of FIG. 3.

### DETAILED DESCRIPTION

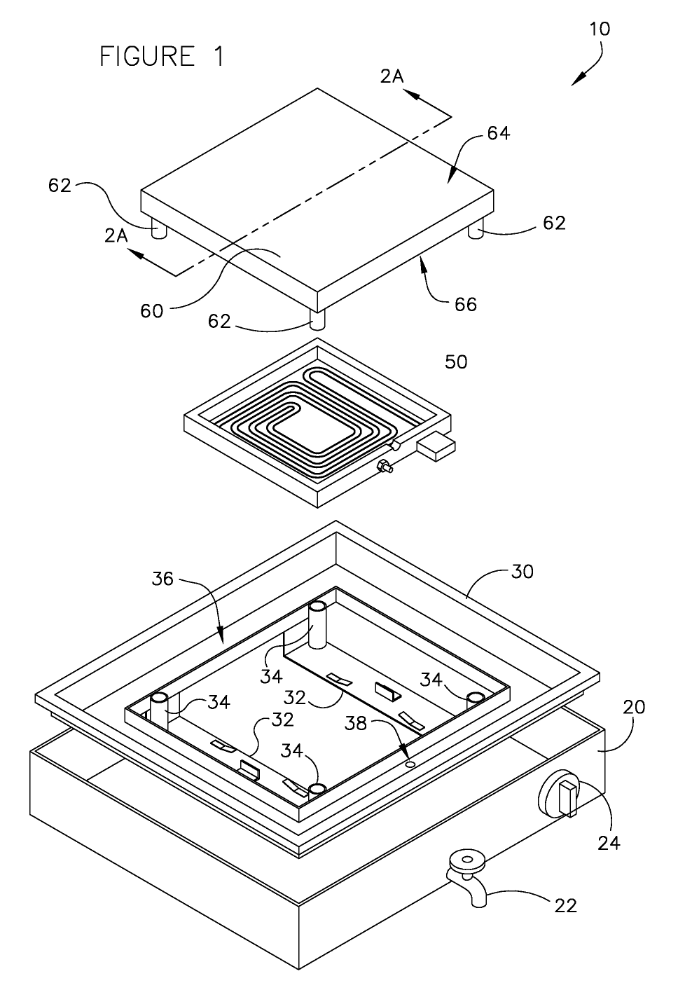

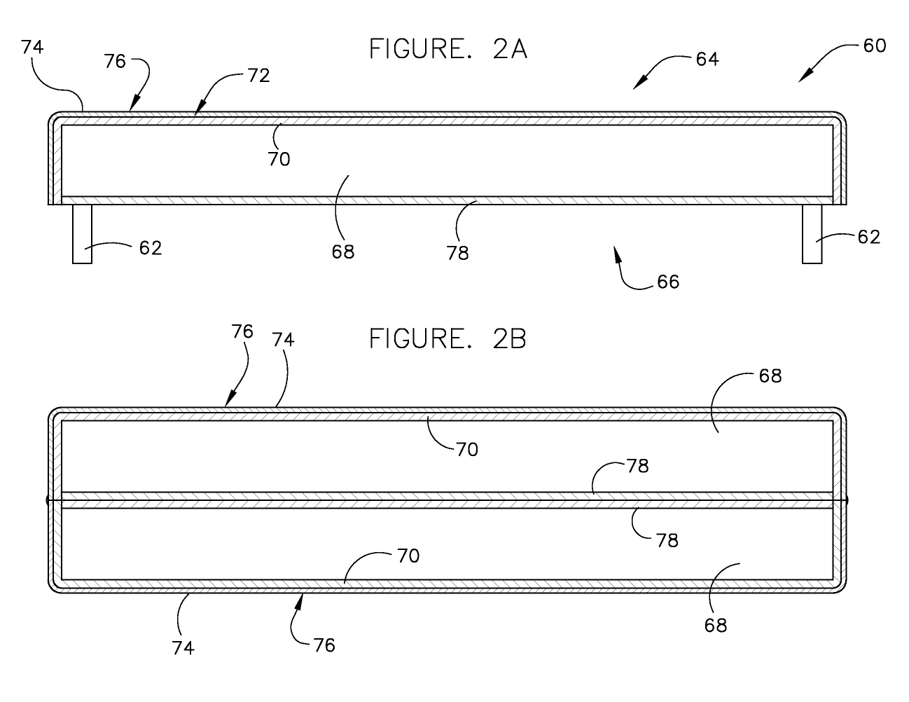

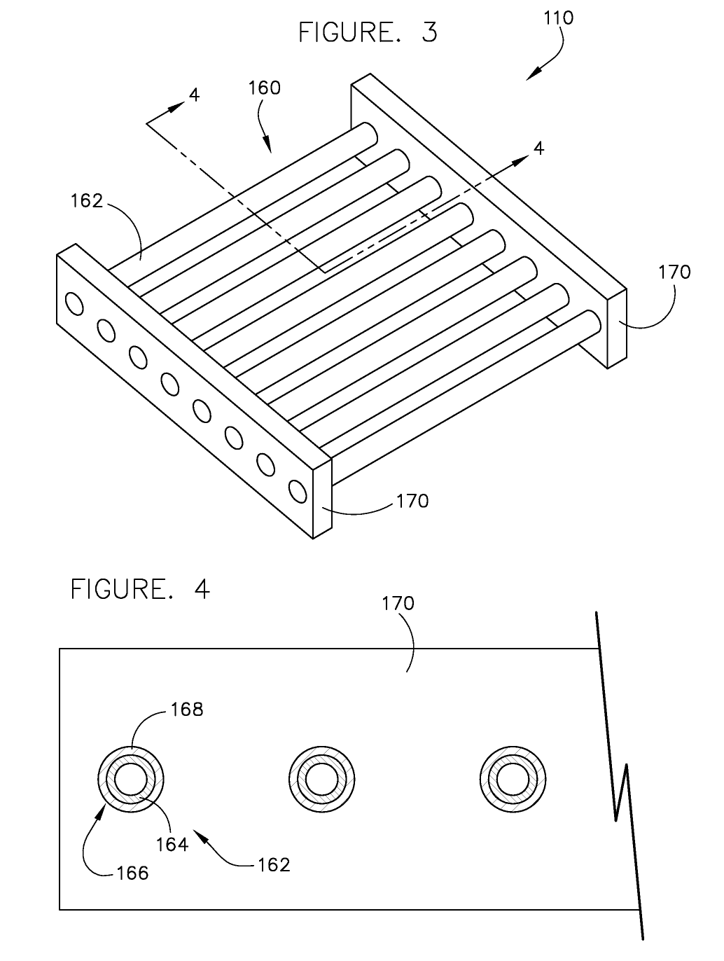

According to the illustrated embodiments, a self-contained high-temperature non-stick cooking device is shown for use in a wide variety of applications, such as a kitchen (or any other suitable food preparation area) associated with facilities such as an educational facility (e.g. school, college, university, etc.), a healthcare facility (e.g. hospital, hospice, extended-care facility, etc.), commercial kitchen (e.g. fine-dining restaurants, multi-unit restaurant operations, take-out and catering service, mobile vendors, caterers, etc.), hotel production and room service, military kitchens, kiosks and other quick-food applications, etc. The self-contained high-temperature non-stick cooking device is shown by way of example to include a relatively flat or planar cooking surface (e.g. plancha, griddle, etc.—see FIGS. 1-2B) and an open-type cooking surface (e.g. grill, grate, etc.—see FIGS. 3-4). However, the cooking device may be adapted for use with other cooking surface configurations (e.g. presses, such as a Panini press, tortilla press, etc.) and may be used in any other suitable application. All such variations are intended to be within the scope of this disclosure.

Referring to FIGS. 1-2B, a self-contained high-temperature non-stick cooking device 10 is shown according to an exemplary embodiment. Cooking device 10 is shown to include a housing 20, a support frame 30 sized to fit within the housing 20, a valve 22 configured to permit drainage of materials from the housing 20 and/or frame 30, a heat source 50 supported by the frame 30, a control device 24 mounted on the frame 30 and operable to control an amount of heat generated by the heat source 50, and a heat-conducting platform 60 (e.g. heat sink, thermal mass, etc.) supported on the frame 30 and disposed generally above the heat source 50.

According to one embodiment, housing 20 is formed from a material such as stainless steel to provide an attractive and corrosion/stain resistant housing for the cooking device. The frame 30 may also be formed from stainless steel and configured to fit within and attach to housing 20. Frame 30 is shown to include crossbeams 32 arranged to support the heat source 50 thereon, and also to include positioning devices 34 (shown as generally cylindrical receptacles) mounted on the frame 30 and/or crossbeams 32 and arranged to receive and support projections 62 extending from the heat-conducting platform 60. Frame 30 further includes a recessed portion 36 (e.g. trough, moat, etc.) extending substantially around an inner perimeter of the frame and intended to receive/collect materials (e.g. waste from cooking food products, liquids generated during cooking and/or cleaning, etc.) and to direct such materials to a drain 38 (e.g. through a sloped surface, or by manually directing the materials to the drain). The drain 38 communicates with valve 22 to permit manual control of release or drainage of the materials from the cooking device 10 to a suitable receptacle or containment (not shown). Housing 20 may be configured for a semi-permanent installation and transportable (e.g. for use in mobile applications) or may be configured for permanent installation (e.g. “built-in” to a platform or work surface such as a countertop, cooking suite, cabinet, or other food preparation surface—not shown).

According to the illustrated embodiment, heating source 50 is supported by crossbeams 32 at a location disposed directly beneath and closely adjacent to an underside of heat-conducting platform 60. Heat source 50 may be an electrically operated device configured to generate heat by electrical resistance heating, induction heating, infrared heating or other suitable form of heating. Electrical wires or other suitable electricity conductors are routed from heating source 50 to control device 24 to permit manual adjustment of the amount of electrical power directed to elements of the heating source 50 and the amount of heat generated by the heating element. Control device 24 may include an adjustment device, such as a knob, slide, pushbutton, or other suitable control and may include a thermostat or the like configured to regulate the temperature of the heat-conducting platform 60 based on a signal representative of a temperature of the heat-conducting platform provided by a thermocouple, RTD, or the like (not shown) embedded within (or otherwise coupled to) the heat-conducting platform 60. The heating source 50 is shown as a single heating source, however, the heating source may be arranged in one or more sections or elements (e.g. regions, portions, etc.) that may be independently operated or controlled to permit different portions of the heat sink to operate at different temperatures (e.g. on/off, high/low, cook/warm, or any other desirable configuration). According to another alternative embodiment, the heating source may be omitted and the frame may be provided with an open space (e.g. no crossbeams or the like) for placement of the cooking device over another form of heat source (such as a flame from a gas burner, charcoal, etc.).

Referring further to FIGS. 1-2A, the heat-conducting platform 60 for the cooking device 10 is shown according to an exemplary embodiment. Heat-conducting platform 60 is formed from a relatively soft, heat conducting, hardenable material to permit enhanced heat conduction from the heat source and to the food products cooked on a surface of the heat-conducting platform. The heat-conducting, hardenable material has a thickness within a range of approximately ⅛ inch to 1 inch, and more preferably within a range of approximately ⅜ inch to ¾ inch. According to one embodiment, the heat conducting material is a carbon steel, such as AISI 1020 carbon steel, although other types of steel or steel alloys may be used. According to an alternative embodiment, other metals, such as copper, brass, aluminum or iron may be used.

Heat-conducting platform 60 is shown by way of example to be formed in the shape of a generally planar (e.g. flat, etc.) and rectangular plate, and may have any of a wide variety of shapes (e.g. circular, square, etc.), and having a top side 64 and a bottom side 66 and includes projections 62 (e.g. legs, posts, feet, etc.) configured to engage or be received on or within positioning devices 34 on the frame 30 to locate the heat-conducting platform 60 substantially directly above and closely adjacent to the heating source 50 and over the edge of the perimeter recess 36 on frame 30. The terms “top” and “bottom” are used for convenience and refer to applications where the heat-conducting platform has a cooking surface disposed on the top side of the platform; according to embodiments where the cooking surface of the platform is located on the bottom or underside (e.g. in a tortilla press, Panini press or the like), the orientation of the layers as described herein would be reversed.

Heat-conducting platform 60 includes multiple layers arranged to provide a high-temperature non-stick cooking surface. Heat-conducting platform 60 includes a core 68 (e.g. substrate, etc.) of heat conducting material. The top surface or side 64 and side edges of heat-conducting platform 60 are hardened to provide a hard, durable, wear-resistant surface and may be hardened by heat treating, case-hardening, or other suitable process, to provide a hardened layer 70. According to one embodiment, the hardened layer 70 has a hardness of approximately Rockwell C 20 (HRC20) or greater, although other levels of hardness may be used as desired for other applications. An outer surface of hardened layer 70 is polished to a mirror-like finish of less than about 20 micro inches and preferable 10-16 micro inches, and more preferably 2-6 micro inches (e.g. using a buffing machine or other appropriate device and suitable abrasive(s) or the like) to provide a polished surface 72 intended to reduce porosity and to create a smooth surface for receiving a non-stick ceramic coating. A non-stick ceramic coating (e.g. film, layer, etc.) is applied to polished surface 72 to provide a non-stick layer 74, an outer surface 76 of which comprises the cooking surface of the cooking device. According to one embodiment, the ceramic coating is zirconium nitride and is applied by a physical or chemical vapor deposition process. According to an alternative embodiment, other ceramic coating materials may be used, such as titanium nitride, chrome nitride, aluminum nitride, or a combination thereof, etc. and may be applied using any suitable process. Heat-conducting platform 60 further includes a high-emissivity (e.g. black-body, non-reflective, heat absorbing, etc.) coating or layer 78 applied on bottom side 66 and is intended to enhance the absorption of heat (e.g. infrared radiation, etc.) by core 68 from heat source 50. According to one embodiment, non-reflective layer 72 comprises a high-temperature, non-reflective black-body material such as black oxide, carbon black, or the like (e.g. oxides and nitrates of metals) and is applied to bottom surface 66 by a painting, enameling, heat treatment, spraying, chemical or physical vapor deposition process of the like, however other high-temperature non-reflective black-body materials and application by other suitable processes may be used.

According to other embodiments, the heat-conducting platform may be formed with a top surface having a desired pattern designed to impart the pattern on the food product (e.g. ridges and valleys for use in a Panini press, crisscrossed ridges for use in a waffle iron, etc.). In such applications, two heat sink portions may be provided to movably engage one another for “pressing” the food product therebetween (with one or both platforms having such a desired pattern).

Accordingly, a method of making a self-contained non-stick high-temperature cooking device may include any one or more of the following steps. Providing a housing for the cooking device. Providing a frame for the cooking device, the frame designed to engage the housing. Providing a heat source supported or accommodated by the frame and operationally controlled by a control device coupled to the housing. Providing a heat-conducting platform formed from a heat conductive and hardenable material. Making the appropriate shape cooking surface from the heat conductive and hardenable material. Hardening at least one surface of the heat conductive and hardenable material to provide a hardened surface. Polishing the hardened surface of the heat conductive and hardenable material to provide a polished surface. Applying a non-stick ceramic coating to the polished surface to provide a non-stick layer having an outer surface defining a cooking surface. Providing a heat-absorbing black-body coating or layer on an underside of the heat-conducting platform. Coupling the housing to a work surface for use by users in cooking or finishing articles such as food products on the cooking surface. As illustrated more particularly in FIG. 2B, the method may also include the steps of coupling two heat-conducting platforms together in a back-to-back manner to process two heat-conducting platforms at the same time, hardening the outer surfaces of the two heat-conducting platforms, polishing the hardened surface to a mirror finish, and applying a ceramic coating to the mirror finish to provide a non-stick layer, separating the two heat-conducting platforms from one another, and installing each heat-conducting platform in a respective frame/housing to form a cooking device.

Referring to FIGS. 3 and 4, another self-contained high-temperature non-stick cooking device 110 is shown according to an exemplary embodiment. Cooking device 110 is shown to include a heat-conducting platform 160 in the form of a plurality or series of substantially parallel bars 162 (e.g. rods, strips, etc.). According to the illustrated embodiment, bars 162 are solid cylindrical bars formed from a heat conductive and hardenable material such as AISI-1020 carbon steel and having a diameter within a range of approximately ⅛ inch to 1 inch and more preferably within a range of ⅜ inch to ½ inch and arranged to provide a cooking surface in the form of a grill. According to alternative embodiments, the bars may have any desired shape or pattern and arranged in any desired pattern to provide other forms of cooking surfaces (e.g. barbecue grates, broiler grates, etc.). Bars 162 are processed in a manner as previously described for other embodiments of the heat-conducting platform(s) and includes hardening an outer surface of the bars by heat treating or case hardening to provide a hardened layer 164, polishing an outer surface of the hardened layer to a mirror finish to provide a polished layer 166, and applying a coating of a ceramic material to the polished surface to provide a non-stick layer 168. Cooking device 110 is also shown to include support members 170 designed to receive opposite ends of bars 162 to maintain the bars in a desired orientation or pattern. According to one embodiment, support members 170 may be designed to slidably (or otherwise) engage an existing structure or heat source (such as an electric or gas grill or broiler, oven, barbeque pit, etc.—not shown). According to another embodiment, support members may be arranged to permanently engage an existing structure or heat source for a fixed (e.g. long-term, etc.) operation.

According to any exemplary embodiment of the present invention, a self-contained high-temperature multi-layer non-stick cooking device is provided for cooking or finishing food articles in any of a wide variety of facilities and applications. The cooking device includes a heat-conducting platform having a hardened surface that is polished to a mirror finish and has applied thereto a ceramic coating (preferably zirconium nitride) to provide a durable, non-stick cooking surface capable of operating at high temperatures. The heat-conducting platform is disposed above and closely adjacent to a heat source for transferring heat from the heat source to the cooking surface. The heat conducting platform may be provided in any of a wide variety of shapes and sizes and may include a bottom surface or underside with a non-reflective heat-absorbing coating intended to enhance the transfer of heat from the heat source to food products being cooked or finished on the cooking surface. The cooking device is intended to be installed in a permanent or semi-permanent manner into a work surface or other suitable device for use in cooking and/or finishing food in a facility.

It is also important to note that the construction and arrangement of the elements of the self-contained high-temperature non-stick cooking device as shown in the preferred and other exemplary embodiments is illustrative only. Although only a few embodiments of the present inventions have been described in detail in this disclosure, those skilled in the art who review this disclosure will readily appreciate that many modifications are possible (e.g., variations in sequence, sizes, dimensions, structures, shapes, profiles and proportions of the various elements, values of parameters, mounting arrangements, use of materials, orientations, compositions of materials, etc.) without materially departing from the novel teachings and advantages of the subject matter recited. For example, elements shown as integrally formed may be constructed of multiple parts or elements show as multiple parts may be integrally formed. It should also be noted that the self-contained high-temperature non-stick cooking device may be used in association with a wide variety of applications (e.g. hospital and/or healthcare facilities, restaurants, private residences, hotels, private clubs, fast-food type applications, portable food vendors, banquet and catering operations, etc.) and that the elements of the system may be provided in any suitable size, shape, material and appearance that meets applicable design and performance standards. Accordingly, all such modifications are intended to be included within the scope of the present inventions. Other substitutions, modifications, changes and omissions may be made in the design, operating conditions and arrangement of the preferred and other exemplary embodiments without departing from the spirit of the present inventions.

The order or sequence of any process or method steps may be varied or re-sequenced according to alternative embodiments. Other substitutions, modifications, changes and omissions may be made in the design, operating configuration and arrangement of the preferred and other exemplary embodiments without departing from the spirit of the inventions as expressed in the appended claims.

What is claimed is:

1. A self-contained non-stick high-temperature cooking device, comprising:
a heat-conducting platform having a first side and a second side;
a hardened layer disposed on the first side of the heat-conducting platform and having a polished surface;
a non-stick layer disposed on the polished surface;
a substantially non-reflective black-body coating disposed on the second side of the heat-conducting platform; and
a heat source disposed adjacent to the non-reflective coating for heating the heat-conducting platform.

2. The device of claim 1 wherein the heat-conducting platform comprises a steel plate.

3. The device of claim 2 wherein the steel plate comprises a thickness within the range of substantially ⅜ inches to ¾ inches.

4. The device of claim 2 wherein the heat-conducting platform and the heat source are packaged within a frame to provide a transportable cooking device.

5. The device of claim 2 wherein the heat-conducting platform and the heat source are packaged within a recess in a work surface.

6. The device of claim 1 wherein the heat source is an electrical resistance heating element.

7. The device of claim 1 wherein the heat source is an infrared heating element.

8. The device of claim 1 wherein the heat source is an induction heating element.

9. The device of claim 1 wherein the non-stick layer comprises a zirconium nitride film.

10. A method of making a self-contained non-stick high-temperature cooking device, comprising:
providing a heat-conducting platform;
hardening a surface of the heat-conducting platform to provide a hardened layer;
polishing the hardened layer to provide a polished surface;
depositing a layer of non-stick material on the polished surface, the layer of non-stick material configured to receive a food product thereon; and
providing a heat source adjacent to the heat-conducting platform and operable to heat the heat-conducting platform and the layer of non-stick material.

11. The method of claim 10 wherein the heat-conducting platform comprises a first plate and a second plate, each plate having a first side and a second side and formed of a heat conductive material, wherein the first sides of each plate are at least temporarily joined to one another, so that the second sides of each plate are hardened in a single operation, and so that the non-stick material is deposited on the second sides of each plate in a single operation.

12. The method of claim 10 further comprising the step of separating the first plate from the second plate, and the step of applying a substantially non-reflective black-body coating to the first side of each of the plates.

13. The method of claim 10 wherein the heat-conducting platform comprises a plurality of rods arranged in a substantially parallel manner to form a grilling surface.

14. The method of claim 10 further comprising the step of mounting the heat source and the heat-conducting platform on a frame.

15. The method of claim 10 wherein the frame is at least one of a portable frame and a built-in frame for use in a countertop.

16. A self-contained non-stick high-temperature cooking device, comprising:
a plate formed from a heat conductive material, the plate having a perimeter and a first side and a second side;
a hardened layer formed on the first side of the plate and having a polished surface;
a non-stick layer disposed on the polished surface, the non-stick layer configured to receive articles thereon to be heated by the plate;
a substantially non-reflective black-body coating disposed on the second side of the plate;
a heating element disposed adjacent to the non-reflective coating and configured to heat the plate; and
a frame having a first surface supporting the heating element, and a second surface supporting the plate above the heating element, and a trough at least partially surrounding the perimeter of the plate.

17. The device of claim 16 wherein the non-stick layer comprises zirconium nitride.

18. The device of claim 17 wherein first side of the plate comprises a series of ridges and grooves.

19. The device of claim 16 further comprising a control device configured to permit selective adjustment of the temperature of the plate by controlling an amount of heat generated by the heating element.
